(19) United States
(12) Patent Application Publication
(10) Pub. No.: US 2022/0282735 A1
(43) Pub. Date: Sep. 8, 2022

(54) BLOWER

(71) Applicant: DENSO CORPORATION, Kariya-city (JP)

(72) Inventor: Syo KOSAKA, Kariya-city (JP)

(21) Appl. No.: 17/824,337

(22) Filed: May 25, 2022

Related U.S. Application Data
(63) Continuation of application No. PCT/JP2020/038775, filed on Oct. 14, 2020.

(30) Foreign Application Priority Data
Nov. 29, 2019 (JP) 2019-217021

(51) Int. Cl. F04D 29/42; F04D 25/08; B60H 3/06

(52) U.S. Cl. CPC F04D 29/424; F04D 25/08; B60H 3/0608; B60H 2001/00135

(57) ABSTRACT

A blower includes an introduction duct provided in an air introduction box. A filter is provided downstream of the introduction duct and upstream of an impeller. A separation cylinder is formed in a cylindrical shape and is provided in the impeller. An inner wall of an air inlet portion of the separation cylinder is provided not overlap with an inner wall of an air outlet portion of the introduction duct over the entire circumference.

### CROSS-REFERENCE TO RELATED APPLICATIONS

The present application is a continuation application of International Patent Application No. PCT/JP2020/038775 filed on Oct. 14, 2020, which designated the U.S. and claims the benefit of priority from Japanese Patent Application No. 2019-217021 filed on Nov. 29, 2019. The entire disclosures of all of the above applications are incorporated herein by reference.

### TECHNICAL FIELD

The present disclosure relates to a blower.

### BACKGROUND

A blower is used in an air conditioner for a vehicle to suck in and blow out air outside the cabin and air inside the cabin.

### SUMMARY

According to an aspect of the present disclosure, a blower for an air conditioner in which an inside/outside air two-layer mode is to be set to supply a first air and a second air separately to a cabin, the blower includes:

an air introduction box having a first introduction port into which the first air is introduced and a second introduction port into which the second air is introduced;

an introduction duct provided in the air introduction box, the first air flowing inside the introduction duct and the second air flowing outside the introduction duct when the inside/outside air two-layer mode is set;

a casing that forms a ventilation path through which the first air and the second air flow on a downstream side of the air introduction box;

an impeller provided inside the casing to suck in the first air and the second air introduced into the air introduction box and blow out the first air and the second air into a first air passage and a second air passage on a downstream side of the impeller;

a filter arranged on a downstream side of the introduction duct and an upstream side of the impeller so as to capture a foreign matter contained in air flowing from an inside and an outside of the introduction duct to the impeller; and

a separation cylinder arranged inside the impeller and having an air inlet portion adjacent to the filter, the separation cylinder being formed so as to extend radially outward from the air inlet portion through the inside of the impeller.

### BRIEF DESCRIPTION OF THE DRAWINGS

FIG. 1 is a cross-sectional view of a blower according to a first embodiment.

FIG. 2 is a cross-sectional view taken along a line II-II in FIG. 1.

FIG. 3 is a view corresponding to FIG. 2 in a modification of the first embodiment.

FIG. 4 is a cross-sectional view of a blower according to a second embodiment.

FIG. 5 is a perspective view of a filter of the blower according to the second embodiment.

FIG. 6 is an exploded view of the filter of the blower according to the second embodiment.

FIG. 7 is a view corresponding to FIG. 5 in a modification of the second embodiment.

FIG. 8 is a cross-sectional view of a blower according to a third embodiment.

FIG. 9 is a perspective view of a filter and an introduction duct of the blower according to the third embodiment.

FIG. 10 is an exploded view of the filter and the introduction duct of the blower according to the third embodiment.

FIG. 11 is a cross-sectional view of a blower according to a fourth embodiment.

FIG. 12 is an exploded view of a filter and a separation cylinder of the blower according to the fourth embodiment.

FIG. 13 is a cross-sectional view of a blower according to a fifth embodiment.

FIG. 14 is an exploded view of a filter, an introduction duct, and a separation cylinder of the blower according to the fifth embodiment.

FIG. 15 is a cross-sectional view of a blower according to a sixth embodiment.

FIG. 16 is a cross-sectional view taken along a line XVI-XVI of FIG. 15.

### DESCRIPTION OF EMBODIMENTS

To begin with, examples of relevant techniques will be described.

Conventionally, a blower is used in a vehicle air conditioner capable of setting an inside/outside air two-layer mode. The blower is a one-sided suction type blower capable of simultaneously sucking in air outside the cabin (hereinafter referred to as outside air) and air inside the cabin (hereinafter referred to as inside air) and blowing them out separately. The blower is equipped with an introduction duct, a filter, a separation cylinder, and an impeller, inside an air introduction box and a scroll casing. The introduction duct and the separation cylinder are arranged coaxially with each other, and the filter is interposed between the introduction duct and the separation cylinder. An inner diameter of an air outlet of the introduction duct facing the filter and an inner diameter of an air inlet of the separation cylinder facing the filter are substantially the same.

When the inside/outside air two-layer mode is set, the inside air introduced from the inside air introduction port formed in the air introduction box flows inside the introduction duct, passes through the filter, and then passes through the inside of the separation cylinder so as to be sucked into the impeller. Then, the inside air is blown out to the first air passage outside the impeller. On the other hand, the outside air introduced from the outside air introduction port formed in the air introduction box flows outside the introduction duct, passes through the filter, flows outside the separation cylinder so as to be sucked into the impeller. Then, the outside air is blown out to the second air passage.

The air flowing through the first air passage and the second air passage of the blower is supplied to an air conditioning unit of the air conditioner. The temperature and humidity of air are adjusted, and then the air is blown out from each outlet into the cabin. The outside air flowing through the second air passage of the blower is blown out to the front windshield or the like mainly from the defroster outlet or the like in the cabin after passing through the air conditioning unit.

In the blower, however, a filter is provided between the introduction duct and the separation cylinder. When the inside/outside air two-layer mode is set, it is conceivable that the inside air flowing inside the introduction duct from the inside air introduction port diffuses when passing through the filter. A part of the inside air may be mixed into the flow path outside the separation cylinder. As described above, the outside air flowing through the flow path outside the separation cylinder is blown out from the defroster outlet to the front windshield of the vehicle via the air conditioning unit. If the mixing ratio of the inside air to the outside air flowing through the flow path outside the separation cylinder increases, the front windshield becomes cloudy.

The present disclosure provides a blower in which it is possible to reduce the mixing ratio of the inside air with the outside air in the inside/outside air two-layer mode.

According to one aspect of the present disclosure, a blower for an air conditioner in which an inside/outside air two-layer mode is to be set to supply a first air and a second air separately to a cabin, the blower includes:

an air introduction box having a first introduction port into which the first air is introduced and a second introduction port into which the second air is introduced;

an introduction duct provided in the air introduction box, the first air flowing inside the introduction duct and the second air flowing outside the introduction duct when the inside/outside air two-layer mode is set;

a casing that forms a ventilation path through which the first air and the second air flow on a downstream side of the air introduction box;

an impeller provided inside the casing to suck in the first air and the second air introduced into the air introduction box and blow out the first air and the second air into a first air passage and a second air passage on a downstream side of the impeller;

a filter arranged on a downstream side of the introduction duct and an upstream side of the impeller so as to capture a foreign matter contained in air flowing from an inside and an outside of the introduction duct to the impeller; and

a separation cylinder arranged inside the impeller and having an air inlet portion adjacent to the filter, the separation cylinder being formed so as to extend radially outward from the air inlet portion through the inside of the impeller.

When the first air is air inside the cabin and the second air is air outside the cabin, an inner wall of the air inlet portion of the separation cylinder is located outside an inner wall of an air outlet portion of the introduction duct over an entire circumference when viewed in an axial direction of the impeller.

When the first air is air outside the cabin and the second air is air inside the cabin, an inner wall of the air inlet portion of the separation cylinder is located inside an inner wall of the air outlet portion of the introduction duct over an entire circumference when viewed in an axial direction of the impeller.

Accordingly, in case where the first air is the inside air (that is, the vehicle interior air) and the second air is the outside air (that is, the vehicle exterior air), when the inside/outside air two-layer mode is set, almost all of the inside air flowing inside the introduction duct flows into the air inlet portion of the separation cylinder after passing through the filter. Therefore, when the inside/outside air two-layer mode is set, the inside air is suppressed from being mixed into the flow path outside the separation cylinder. Thus, the mixing ratio of the inside air to the outside air flowing through the flow path outside the separation cylinder is reduced. Therefore, when the outside air is blown out from the defroster outlet, the window fogging can be restricted.

On the other hand, in case where the first air is the outside air and the second air is the inside air, almost all of the inside air as the second air flowing outside the introduction duct flows to the flow path outside the separation cylinder, when the inside/outside air two-layer mode is set, after passing through the filter. Therefore, when the inside/outside air two-layer mode is set, the inside air is suppressed from being mixed into the inner flow path of the separation cylinder, so that the mixing ratio of the inside air to the outside air flowing through the inner flow path of the separation cylinder is reduced. Therefore, when the outside air is blown out from the defroster outlet, the window fogging can be restricted.

According to another viewpoint, a blower for an air conditioner in which an inside/outside air two-layer mode is to be set to supply a first air and a second air separately to a cabin, the blower includes:

an air introduction box having a first introduction port into which the first air is introduced and a second introduction port into which the second air is introduced;

an introduction duct provided in the air introduction box, the first air flowing inside the introduction duct and the second air flowing outside the introduction duct when the inside/outside air two-layer mode is set;

a casing that forms a ventilation path through which the first air and the second air flow on a downstream side of the air introduction box;

an impeller provided inside the casing to suck in the first air and the second air introduced into the air introduction box and blow out the first air and the second air into a first air passage and a second air passage on a downstream side of the impeller;

a filter arranged on a downstream side of the introduction duct and an upstream side of the impeller so as to capture a foreign matter contained in air flowing from an inside and an outside of the introduction duct to the impeller;

a separation cylinder arranged inside the impeller and having an air inlet portion adjacent to the filter, the separation cylinder being formed so as to extend radially outward from the air inlet portion through the inside of the impeller; and

a partition plate provided on the filter to partition an inside space of the filter into a plurality of regions so that air flowing out of the air outlet portion of the introduction duct flows into the air inlet portion of the separation cylinder via the filter.

Accordingly, the first air flowing out of the air outlet portion of the introduction duct, when the inside/outside air two-layer mode is set, flows through the inner region partitioned by the partition plate when passing through the filter, and almost all of the first air flows into the air inlet portion of the separation cylinder. Therefore, when the first air is the inside air and the second air is the outside air, the inside air is suppressed from leaking to the flow path outside the separation cylinder while the inside/outside air two-layer mode is set. Thus, the mixing rate of inside air relative to the outside air flowing through outside the separation cylinder is reduced. Therefore, when the outside air is blown out from the defroster outlet, the window fogging can be restricted.

When the first air is the outside air and the second air is the inside air, the inside air flowing outside the introduction duct is restricted from leaking to the inside of the separation cylinder when the inside/outside air two-layer mode is set. Thus, the mixing rate of the inside air relative to the outside air flowing through the inside of the separation cylinder is reduced. Thus, when the outside air is blown out from the defroster outlet, the window fogging can be restricted.

Embodiments of the present disclosure will now be described with reference to the drawings. In the following embodiments, the same or equivalent parts are denoted by the same reference numerals, and their descriptions will be omitted. In the following description, the terms upper, lower, left, and right are used for convenience of explanation, and do not mean a direction/orientation of each member mounted on a vehicle.

### First Embodiment

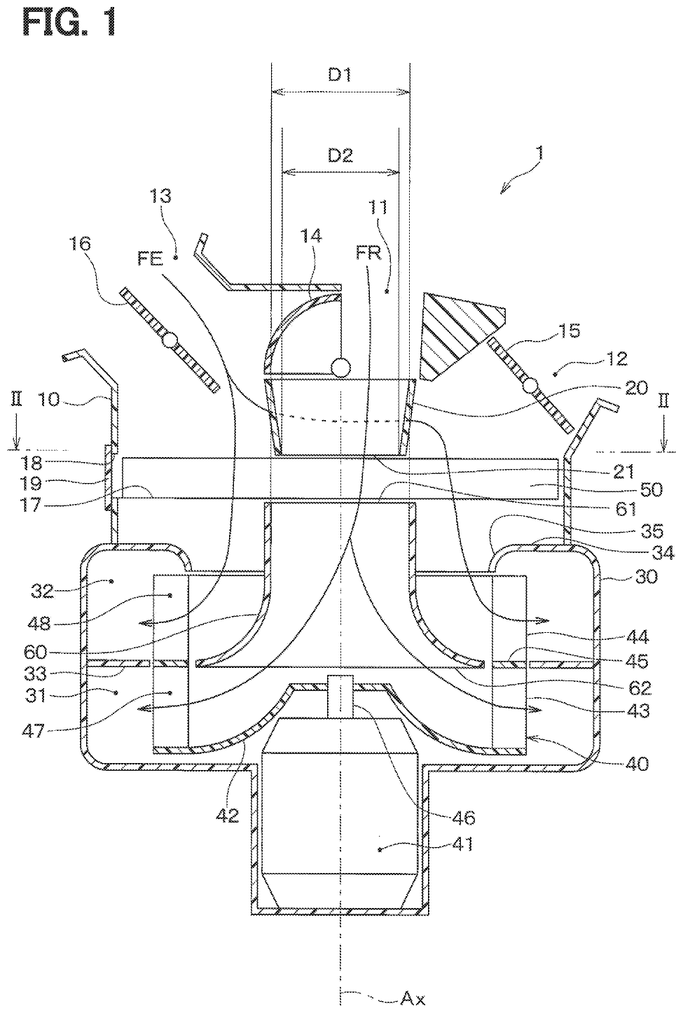

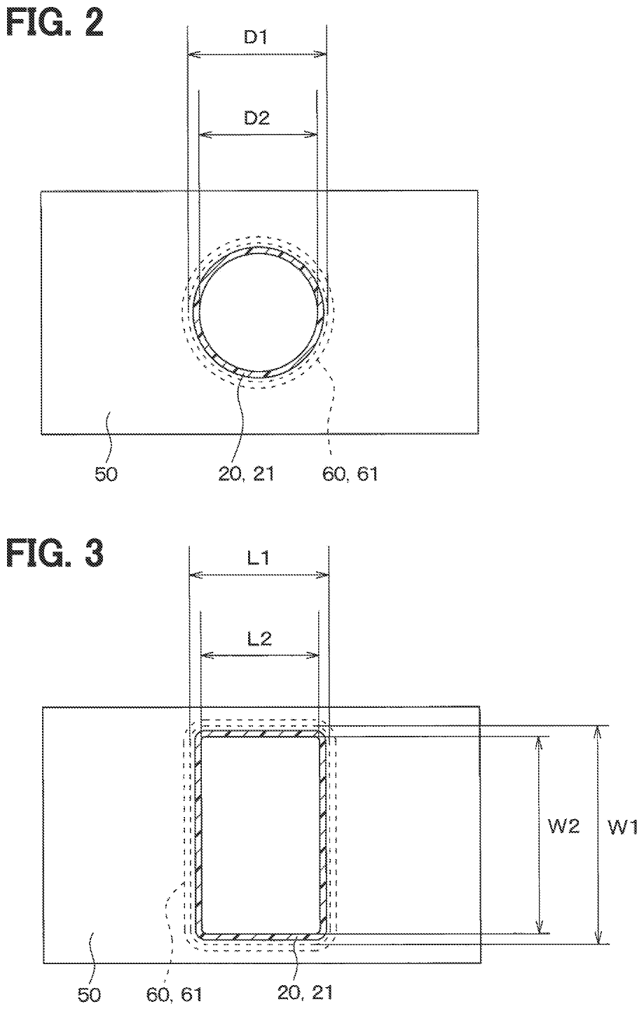

A first embodiment will be described with reference to FIGS. 1 and 2. A blower 1 of the first embodiment is used for an air conditioner of a vehicle. The air conditioner is configured to set an inside/outside air two-layer mode in which the first air and the second air are separately supplied to the vehicle interior. In the first embodiment, the first air is air inside the cabin (hereinafter referred to as “inside air”) and the second air is air outside the cabin (hereinafter referred to as “outside air”). That is, the blower 1 of the first embodiment has a configuration capable of simultaneously sucking in the inside air as the first air and the outside air as the second air and blowing out the first air and the second air separately. The air blown out from the blower 1 (that is, inside air and outside air) is supplied to an air conditioning unit (not shown) of the air conditioner. The air conditioning unit can generate conditioned air in which the temperature and humidity of the air supplied from the blower 1 are adjusted, and blow the conditioned air into the vehicle interior from each outlet.

As shown in FIGS. 1 and 2, the blower 1 includes an air introduction box 10, an introduction duct 20, a scroll casing 30, an impeller 40, a filter 50, and a separation cylinder 60. In the following description, a radial direction of a virtual circle drawn on a plane orthogonal to the rotation axis Ax of the impeller 40 with an arbitrary point on the rotation axis Ax of the impeller 40 as the center is referred to “a radial direction of the impeller 40”. A circumferential direction of the virtual circle is called “a circumferential direction of the impeller 40”. It is assumed that the rotation axis Ax of the impeller 40 coincides with the shaft core of the impeller 40.

The air introduction box 10 is arranged above the blower 1. The air introduction box 10 has a first inside air introduction port 11, a second inside air introduction port 12, and an outside air introduction port 13. The first inside air introduction port 11 and the second inside air introduction port 12 are openings for introducing inside air inside the air introduction box 10. The outside air introduction port 13 is an opening for introducing outside air inside the air introduction box 10. The first inside air introduction port 11 and the second inside air introduction port 12 are examples of a first introduction port into which the first air is introduced. Further, the outside air introduction port 13 is an example of a second introduction port into which the second air is introduced.

An inside/outside air door 14, an inside air door 15, an outside air door 16, the introduction duct 20, and the like are provided inside the air introduction box 10. The inside/outside air door 14 selectively introduces air into the introduction duct 20 from the first inside air introduction port 11 and the outside air introduction port 13. The inside air door 15 opens and closes the second inside air introduction port 12. The outside air door 16 opens and closes the outside air introduction port 13. The inside/outside air door 14 is composed of a rotary door. Each of the inside air door 15 and the outside air door 16 is composed of a butterfly door.

The inside/outside air door 14 may be composed of a door other than the rotary door (for example, a butterfly door). Further, the inside air door 15 and the outside air door 16 may be composed of a door other than the butterfly door (for example, a rotary door).

The introduction duct 20 is formed in a cylindrical shape and is provided between the inside/outside air door 14 and the filter 50 inside the air introduction box 10. The introduction duct 20 is configured to guide the air introduced from the first inside air introduction port 11 and the outside air introduction port 13, which are selectively opened and closed by the inside/outside air door 14, to a predetermined region of the filter 50. In the first embodiment, the shape of the introduction duct 20 is circular in the cross section perpendicular to the axis Ax. However, the shape of the introduction duct 20 is not limited to this, and various shapes such as an elliptical shape, a polygonal shape, and a polygonal shape having rounded corners can be adopted in the cross section perpendicular to the axis Ax.

The filter 50 is provided on the downstream side of the introduction duct 20 and on the upstream side of the impeller 40 and the separation cylinder 60 in the ventilation passage formed inside the air introduction box 10. Specifically, the filter 50 is provided so as to be in contact with or adjacent to the air outlet portion 21 of the introduction duct 20. Further, the filter 50 is provided so as to be in contact with or adjacent to an air inlet portion 61 of the separation cylinder 60. The filter 50 is formed by bending a filter medium for dust removal, such as a non-woven fabric having a predetermined air permeability, into a wavy shape. The filter 50 has an outer shape (specifically, a substantially rectangular shape) corresponding to the ventilation path formed in the air introduction box 10 when viewed from the upper side (that is, in the axial direction of the impeller 40). The filter 50 captures a foreign matter such as particles contained in the air flowing from the inner flow path and the outer flow path of the introduction duct 20 toward the impeller 40.

The filter 50 is installed at a filter installation portion 17 provided in the air introduction box 10. The filter installation portion 17 is formed so that the filter 50 can be installed in the air introduction box 10. The outer wall of the air introduction box 10 has an opening 18 for attaching/detaching the filter 50 to/from the filter installation portion 17. The opening 18 is closed by the lid member 19. The lid member 19 is fixed to the outer wall of the air introduction box 10 by, for example, a screw or a snap fit.

The scroll casing 30 is provided on the downstream side of the air introduction box 10. The scroll casing 30 and the air introduction box 10 form a ventilation path through which air flows. The air that has passed through the filter 50 flows into the ventilation path of the scroll casing 30. The impeller 40 is housed inside the scroll casing 30.

The impeller 40 is a centrifugal fan that rotates by being driven by an electric motor 41. Specifically, the impeller 40 is composed of a sirocco fan. The impeller 40 is not limited to the sirocco fan, and may be composed of a radial fan, a turbo fan, or the like. When the impeller 40 is rotated by the drive of the electric motor 41, the impeller 40 sucks in air from one side in the axial direction and blows out the sucked air in a direction away from the axis Ax.

The impeller 40 has a main plate 42, plural first blades 43, plural second blades 44, and a separation plate 45. The main plate 42 is formed in a disk shape. A shaft 46 of the electric motor 41 is fixed to the center of the main plate 42. The first blades 43 are provided with respect to the main plate 42. The second blades 44 are provided to face the filter 50, and the separation plate 45 is interposed between the first blade 43 and the second blade 44.

The first blades 43 and the second blades 44 are arranged at predetermined intervals in the circumferential direction of the impeller 40. A first blade flow path 47 through which air flows is formed between the first blades 43. A second blade flow path 48 through which air flows is formed between the second blades 44. The separation plate 45 separates the first blade flow path 47 and the second blade flow path 48 from each other. The separation plate 45 connects the first blade 43 and the second blade 44 with each other.

The scroll casing 30 forms ventilation passages 31 and 32 on the radially outer side of the impeller 40. A partition wall 33 is provided between the ventilation passages 31 and 32. The partition wall 33 is provided at a position corresponding to the separation plate 45 of the impeller 40. The partition wall 33 divides the radially outer side of the impeller 40 into the first ventilation passage 31 on one side (lower side in FIG. 1) of the impeller 40 in the axial direction of the impeller 40 and the second ventilation passage 32 on the other side (upper side in FIG. 1) in the axial direction. The first ventilation passage 31 and the second ventilation passage 32 are configured to control the flow of air blown from the impeller 40 in the radial direction to flow along the circumferential direction of the impeller 40 so as to be supplied to an air conditioning unit (not shown).

One side of the scroll casing 30 in the axial direction of the impeller 40 has a suction port forming portion 34 constituting the upper wall of the second ventilation passage 32. An annular bell mouth 35 for forming a suction port for air sucked into the impeller 40 is provided substantially at the center of the suction port forming portion 34. That is, the flow path inside the bell mouth 35 serves as a suction port for air sucked into the impeller 40. The bell mouth 35 is provided between the filter 50 and the impeller 40, and has a curved arc shape in the cross section so that the air passing through the filter 50 smoothly flows to the suction port of the impeller 40.

The separation cylinder 60 is provided at the inner side of the first blade 43 and the second blade 44 in the radial direction of the impeller 40 (hereinafter, simply referred to as “inside the impeller 40”). The separation cylinder 60 is a tubular member extending in the axial direction of the impeller 40, and both ends in the axial direction are open. An opening of the separation cylinder 60 adjacent to the filter 50 is referred to as an air inlet portion 61, and an opening of the separation cylinder 60 opposite to the filter 50 is referred to as a flare opening 62.

In the first embodiment, the shape of the separation cylinder 60 is circular in the cross section perpendicular to the axis Ax. However, the shape of the separation cylinder 60 is not limited to this, and various shapes such as an elliptical shape, a polygonal shape, and a polygonal shape having rounded corners can be adopted in the cross section perpendicular to the axis Ax.

The air inlet portion 61 of the separation cylinder 60 is arranged to face the filter 50 with respect to the impeller 40, and is in contact with or adjacent to the filter 50. The separation cylinder 60 is formed in a flare shape extended from the air inlet portion 61 into the impeller 40 and gradually expands outward in the radial direction as approaching the flare opening 62. The outer edge of the flare opening 62 of the separation cylinder 60 is provided at a position corresponding to the separation plate 45 of the impeller 40. As a result, of the air that has passed through the filter 50, the air flowing through the flow path inside the separation cylinder 60 flows to the first ventilation passage 31 via the first blade flow path 47 of the impeller 40. Of the air that has passed through the filter 50, the air flowing through the flow path outside the separation cylinder 60 flows to the second ventilation passage 32 via the second blade flow path 48 of the impeller 40.

The relationship between the separation cylinder 60 and the introduction duct 20 in the first embodiment will be described with reference to FIGS. 1 and 2. Note that FIG. 2 is a cross-sectional view taken along a line II-II of FIG. 1, but the bent shape of the filter medium of the filter 50 is not shown. Further, in FIG. 2, the air outlet portion 21 of the introduction duct 20 is shown with hatching, and the air inlet portion 61 of the separation cylinder 60 is shown by a broken line.

As shown in FIGS. 1 and 2, the air inlet portion 61 of the separation cylinder 60 is defined to have an inner diameter D1. Further, the air outlet portion 21 of the introduction duct 20 is defined to have an inner diameter D2. In the first embodiment, the shaft core of the separation cylinder 60 and the shaft core of the introduction duct 20 substantially coincide with each other, and a relationship of D1>D2 is satisfied. Therefore, in the first embodiment, the inner wall of the air inlet portion 61 of the separation cylinder 60 is positioned outside the inner wall of the air outlet portion 21 of the introduction duct 20 over the entire circumference when viewed from the axial direction of the impeller 40. As a result, most of the air flowing inside the introduction duct 20 flows into the air inlet portion 61 of the separation cylinder 60 even if it diffuses when passing through the filter 50. Therefore, it is possible to restrict the air flowing inside the introduction duct 20 from leaking to the flow path outside the separation cylinder 60 after passing through the filter 50. In FIGS. 1 and 2, the inner diameter D1 of the air inlet portion 61 of the separation cylinder 60 is larger than the inner diameter D2 of the air outlet portion 21 of the introduction duct 20 by more than the thickness of the introduction duct 20.

The blower 1 can be configured to set an air suction mode such as an inside/outside air two-layer mode in which the outside air and the inside air are simultaneously sucked and separately blown out, an outside air mode in which the outside air is sucked in and blown out, and an inside air mode in which the inside air is sucked in and blown out.

### <Inside/Outside Air Two-Layer Mode>

FIG. 1 shows a state in which the inside/outside air two-layer mode is set in the blower 1. At that time, the inside/outside air door 14 is displaced to a position where the first inside air introduction port 11 and the introduction duct 20 communicate with each other and the communication between the outside air introduction port 13 and the introduction duct 20 is cut off. The inside air door 15 is displaced to a position where the second inside air introduction port 12 is closed. The outside air door 16 is displaced to a position where the outside air introduction port 13 is opened. In this state, when the impeller 40 is rotated by the drive of the electric motor 41, the inside air is introduced from the first inside air introduction port 11 into the introduction duct 20, and the outside air is introduced from the outside air introduction port 13 to the outside of the introduction duct 20.

As shown by the arrow FR in FIG. 1, the inside air introduced from the first inside air introduction port 11 into the introduction duct 20 passes through the filter 50, flows inside the separation cylinder 60 so as to be sucked into the first blade flow path 47 of the impeller 40, and is blown out to the first ventilation passage 31. In the first embodiment, the inner wall of the air inlet portion 61 of the separation cylinder 60 is provided outside the inner wall of the air outlet portion 21 of the introduction duct 20 over the entire circumference. Therefore, most of the inside air flowing from the air outlet portion 21 of the introduction duct 20 to the filter 50 flows into the air inlet portion 61 of the separation cylinder 60 even if it diffuses when passing through the filter medium of the filter 50. Therefore, it is possible to restrict the inside air flowing inside the introduction duct 20 from leaking to the flow path outside the separation cylinder 60 after passing through the filter 50.

As shown by the arrow FE in FIG. 1, the outside air introduced from the outside air introduction port 13 to the outside of the introduction duct 20 passes through the filter 50, and is sucked into the second blade flow path 48 of the impeller 40 from the flow path outside the separation cylinder 60 so as to be blown out to the second ventilation passage 32. In the first embodiment, since the inside air flowing inside the introduction duct 20 is suppressed from leaking to the flow path outside the separation cylinder 60 after passing through the filter 50, the mixing ratio of the inside air to the outside air flowing through the outer flow path of the separation cylinder 60 is suppressed.

The inside air flowing through the first ventilation passage 31 and the outside air flowing through the second ventilation passage 32 are introduced into an air conditioning unit (not shown). The inside air and the outside air are blown out from each outlet to the cabin after adjusted to have a desired temperature and humidity inside the air conditioning unit. When the inside/outside air two-layer mode is set in the blower 1, the outside air flowing through the second ventilation passage 32 is mainly blown out to the front windshield from the defroster outlet provided in the cabin. In the first embodiment, since the mixing ratio of the inside air to the outside air flowing through the second ventilation passage 32 is small, fogging of the front windshield can be reliably restricted.

### <Outside Air Mode>

Although not shown, in the blower 1, when the outside air mode is set, the inside/outside air door 14, the inside air door 15, and the outside air door 16 are displaced as follows. The inside/outside air door 14 is displaced to a position where the outside air introduction port 13 and the introduction duct 20 are communicated with each other and the communication between the first inside air introduction port 11 and the introduction duct 20 is cut off. The inside air door 15 is displaced to a position where the second inside air introduction port 12 is closed. The outside air door 16 is displaced to a position where the outside air introduction port 13 is opened. When the impeller 40 rotates in this state, the outside air introduced from the outside air introduction port 13 flows through both the inside and outside of the introduction duct 20 and the separation cylinder 60, and is blown out to the first ventilation passage 31 and the second ventilation passage 32.

### <Inside Air Mode>

Further, in the blower 1, when the inside air mode is set, the inside/outside air door 14, the inside air door 15, and the outside air door 16 are displaced as follows. The inside/outside air door 14 is displaced to a position where the first inside air introduction port 11 and the introduction duct 20 communicate with each other and the communication between the outside air introduction port 13 and the introduction duct 20 is cut off. The inside air door 15 is displaced to a position where the second inside air introduction port 12 is opened. The outside air door 16 is displaced to a position where the outside air introduction port 13 is closed. When the impeller 40 rotates in this state, the inside air introduced from the first inside air introduction port 11 flows inside the introduction duct 20 and the separation cylinder 60, and is blown out to the first ventilation passage 31. Further, the inside air introduced from the second inside air introduction port 12 flows outside the introduction duct 20 and the separation cylinder 60, and is blown out to the second ventilation passage 32.

In the blower 1 of the first embodiment, when viewed from the axial direction of the impeller 40, the inner wall of the air inlet portion 61 of the separation cylinder 60 is provided outside the inner wall of the air outlet portion 21 of the introduction duct 20 over the entire circumference. As a result, almost all of the inside air flowing inside the introduction duct 20, when the inside/outside air two-layer mode is set, flows into the air inlet portion 61 of the separation cylinder 60 after passing through the filter 50. Therefore, when the inside/outside air two-layer mode is set, the inside air is suppressed from leaking to the flow path outside the separation cylinder 60, so that the mixing rate of the inside air into the outside air flowing through the flow path outside the separation cylinder 60 is reduced. Therefore, when the outside air is blown out from the defroster outlet, the window fogging can be restricted.

A modification of the first embodiment will be described with reference to FIG. 3. In this modification, the shape of the introduction duct 20 and the shape of the separation cylinder 60 are changed with respect to the first embodiment. Note that FIG. 3 corresponds to FIG. 2 referred to in the first embodiment. Similarly to FIG. 2, the air outlet portion 21 of the introduction duct 20 is shown with hatching, and the air inlet portion 61 of the separation cylinder 60 is shown by a broken line.

As shown in FIG. 3, in this modification, the shape of the introduction duct 20 is rectangle in the cross section perpendicular to the axis As, and the rectangular has rounded corners. Further, the shape of the separation cylinder 60 also is rectangular with rounded corners in the cross section perpendicular to the axis Ax. The shaft core of the separation cylinder 60 and the shaft core of the introduction duct 20 are substantially the same.

The short-side inner wall of the air inlet portion 61 of the separation cylinder 60 is defined to have a length L1. The short-side inner wall of the air outlet portion 21 of the introduction duct 20 is defined to have a length L2. At this time, a relationship of L1>L2 is satisfied. Further, the long-side inner wall of the air inlet portion 61 of the separation cylinder 60 is defined to have a width W1. Further, the long-side inner wall of the air outlet portion 21 of the introduction duct 20 is defined to have a width W2. At this time, a relationship of W1>W2 is satisfied. Therefore, even in the modification of the first embodiment, when viewed from the axial direction of the impeller 40, the inner wall of the air inlet portion 61 of the separation cylinder 60 is provided outside the inner wall of the air outlet portion 21 of the introduction duct 20 over the entire periphery. As a result, most of the air flowing inside the introduction duct 20 flows into the air inlet portion 61 of the separation cylinder 60 even if it diffuses when passing through the filter 50. Therefore, it is possible to restrict the air flowing inside the introduction duct 20 from leaking to the flow path outside the separation cylinder 60 after passing through the filter 50. Therefore, this modification can also exert the same effect as that of the first embodiment.

### Second Embodiment

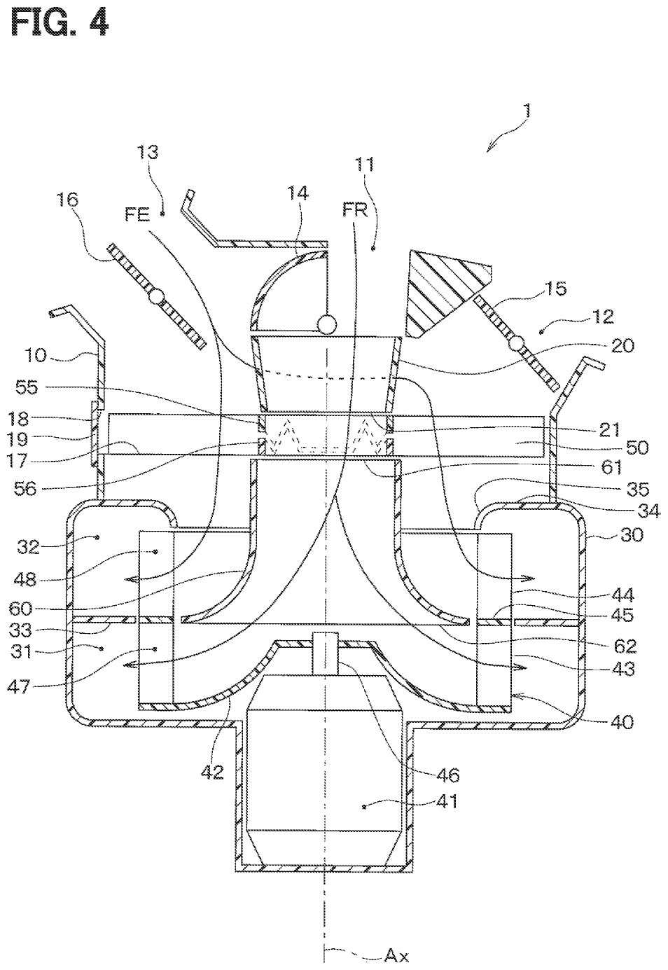

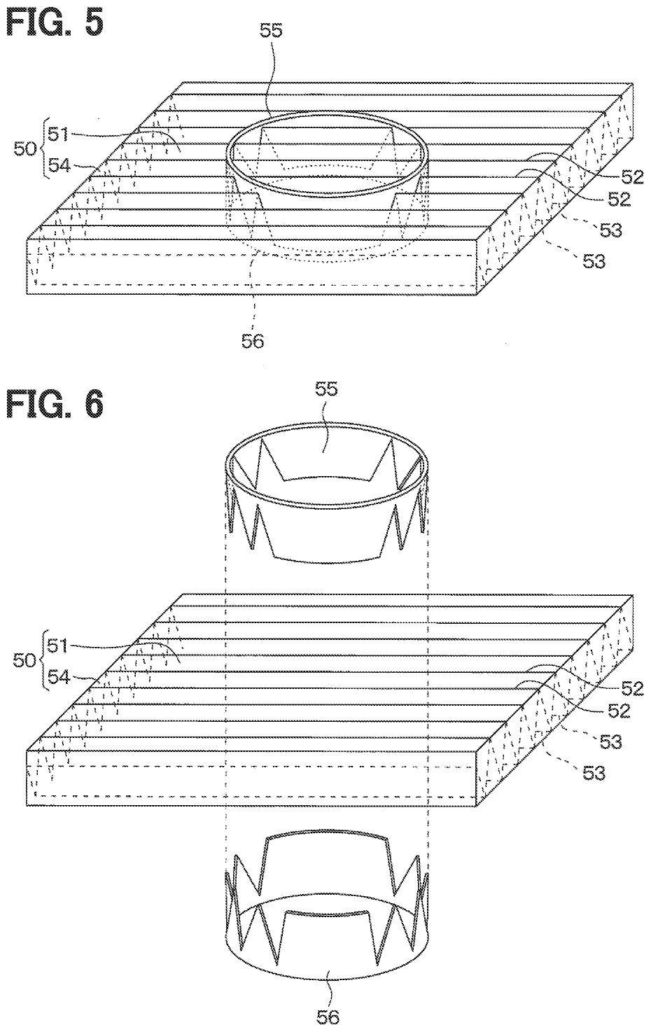

A second embodiment will be described with reference to FIGS. 4 to 6. In the second embodiment, a part of the configuration of the filter 50 is modified with respect to the first embodiment. Since the other parts are the same as those of the first embodiment, only the modified parts are explained. FIG. 5 is a perspective view showing the filter 50 and partition plates 55 and 56 of the blower 1 of the second embodiment, and FIG. 6 is an exploded perspective view.

As shown in FIGS. 4 to 6, in the second embodiment as in the first embodiment, the filter medium 51 of the filter 50 is made of a non-woven fabric or the like having a predetermined air permeability, and has a wavy shape formed to have mountain folds 52 and valley folds 53 alternately. The corrugated shape of the filter medium 51 may be referred to as a fold shape or a pleated shape. The outer edge of the filter medium 51 has an outer edge portion 54 for maintaining its corrugated shape.

In the second embodiment, the partition plates 55 and 56 are provided for the filter medium 51 of the filter 50. The partition plates 55 and 56 are composed of an upper partition plate 55 provided on the upstream side of the filter medium 51 of the filter 50 and a lower partition plate 56 provided on the downstream side of the filter medium 51. The upper partition plate 55 and the lower partition plate 56 are formed in a cylindrical shape.

When viewed from the axial direction of the impeller 40, the upper partition plate 55 and the lower partition plate 56 are formed in a shape and size between the air outlet portion 21 of the introduction duct 20 and the air inlet portion 61 of the separation cylinder 60. The upper partition plate 55 and the lower partition plate 56 may be formed in a shape and size corresponding to the air outlet portion 21 of the introduction duct 20, or in a shape and size corresponding to the air inlet portion 61 of the separation cylinder 60.

The upper partition plate 55 and the lower partition plate 56 may have the same size, or the lower partition plate 56 may be formed larger than the upper partition plate 55.

The upper partition plate 55 and the lower partition plate 56 are located at an intermediate position between the air outlet portion 21 of the introduction duct 20 and the air inlet portion 61 of the separation cylinder 60 when viewed from the axial direction of the impeller 40. The upper partition plate 55 and the lower partition plate 56 may be placed at position corresponding to the air outlet portion 21 of the introduction duct 20 when viewed from the axial direction of the impeller 40, or may be placed at position corresponding to the air inlet portion 61 of the separation cylinder 60.

The upper partition plate 55 is fixed to the filter medium 51 of the filter 50 by adhesion or welding. A portion of the upper partition plate 55 facing the filter medium 51 has an uneven shape (in other words, a jagged shape) corresponding to the corrugated shape of the filter medium 51. Therefore, the portion of the upper partition plate 55 facing the filter medium 51 is inserted into the gap between the mountain fold 52 and the valley fold 53 of the filter medium 51. As a result, the upper partition plate 55 can partition the space on the upstream side of the filter medium 51 into a region inside the upper partition plate 55 and a region outside the upper partition plate 55.

The partition plate 56 is fixed to the filter medium 51 of the filter 50 by adhesion or welding. A portion of the partition plate 56 facing the filter medium 51 has an uneven shape (in other words, a jagged shape) corresponding to the corrugated shape of the filter medium 51. Therefore, the portion of the partition plate 56 facing the filter medium 51 is inserted into the gap between the mountain fold 52 and the valley fold 53 of the filter medium 51. As a result, the lower partition plate 56 can partition the space on the downstream side of the filter medium 51 into a region inside the lower partition plate 56 and a region outside the lower partition plate 56.

FIG. 4 shows a state in which the inside/outside air two-layer mode is set in the blower 1. As shown by the arrow FR in FIG. 4, the inside air introduced from the first inside air introduction port 11 into the introduction duct 20 passes through the filter 50, flows inside the separation cylinder 60, and is sucked into the first blade flow path 47 of the impeller 40 so as to be blown out to the first ventilation passage 31. At that time, in the second embodiment, the inside air flowing from the air outlet portion 21 of the introduction duct 20 to the filter 50 flows through the inner region of the filter 50 partitioned by the upper partition plate 55 and the lower partition plate 56. Therefore, it is possible to restrict the inside air flowing through the inner regions of the upper partition plate 55 and the lower partition plate 56 from diffusing when passing through the filter medium 51 of the filter 50. Therefore, almost all of the inside air that has flowed through the inner regions of the upper partition plate 55 and the lower partition plate 56 flows into the air inlet portion 61 of the separation cylinder 60.

As shown by the arrow FE in FIG. 1, the outside air introduced from the outside air introduction port 13 to the outside of the introduction duct 20 passes through the filter 50, and is sucked into the second blade flow path 48 of the impeller 40 from the flow path outside the separation cylinder 60, so as to be blown out to the second ventilation passage 32. In the second embodiment, as described above, the inside air flowing inside the introduction duct 20 is restricted from diffusing when passing through the filter 50. Therefore, the mixing ratio of the inside air to the outside air flowing through the flow path outside the separation cylinder 60 is small.

The blower 1 of the second embodiment includes the partition plates 55 and 56 inside the filter 50. The partition plates 55 and 56 divide the space inside the filter 50 into a plurality of regions so that the air flowing out from the air outlet portion 21 of the introduction duct 20 flows into the air inlet portion 61 of the separation cylinder 60 via the filter 50.

As a result, almost all of the inside air flowing out from the air outlet portion 21 of the introduction duct 20, when the inside/outside air two-layer mode is set, flows through the inner region partitioned by the partition plates 55 and 56 while passing through the filter 50, and flows into the air inlet portion 61 of the separation cylinder 60. Therefore, when the inside/outside air two-layer mode is set, the inside air is suppressed from leaking to the flow path outside the separation cylinder 60, so that the mixing rate of the inside air into the outside air flowing through the flow path outside the separation cylinder 60 is reduced. Therefore, when the outside air is blown out from the defroster outlet, the window fogging can be reliably restricted.

Further, in the second embodiment, the upper partition plate 55 and the lower partition plate 56 are composed of members separate from the introduction duct 20 and the separation cylinder 60, and are fixed to the filter medium 51 of the filter 50. As a result, the filter 50 and the partition plates 55 and 56 can be integrated and easily attached to and detached from the blower 1.

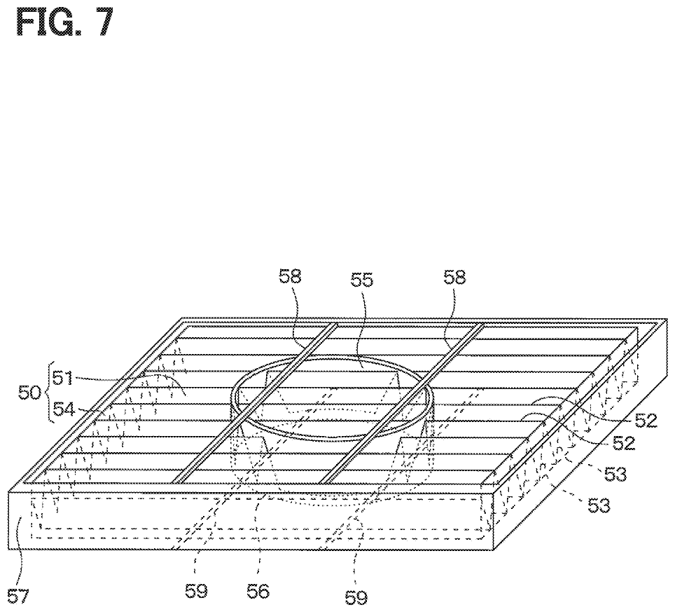

A modification of the second embodiment will be described with reference to FIG. 7, in which the method of fixing the partition plates 55 and 56 is modified with respect to the second embodiment.

As shown in FIG. 7, in this modification, the filter 50 includes a frame body 57 that surrounds the outer side of the filter medium 51. The frame body 57 is formed of, for example, resin or the like, and constitutes the outer frame of the filter 50. The filter medium 51 is housed inside the frame body 57. The upstream side and the downstream side of the frame body 57 are open.

A rod-shaped or plate-shaped upper connecting member 58 is fixed to the frame body 57. The upper partition plate 55 is fixed to the frame body 57 via the upper connecting member 58. The lower partition plate 56 is also fixed to the frame body 57 via a rod-shaped or plate-shaped lower connecting member 59. The method of fixing the frame body 57, the upper connecting member 58, and the upper partition plate 55, and the method of fixing the frame body 57, the lower connecting member 59, and the lower partition plate 56 are various methods such as bonding, welding, fitting, or integral molding. The modification of the second embodiment can also have the same effect as that of the second embodiment.

### Third Embodiment

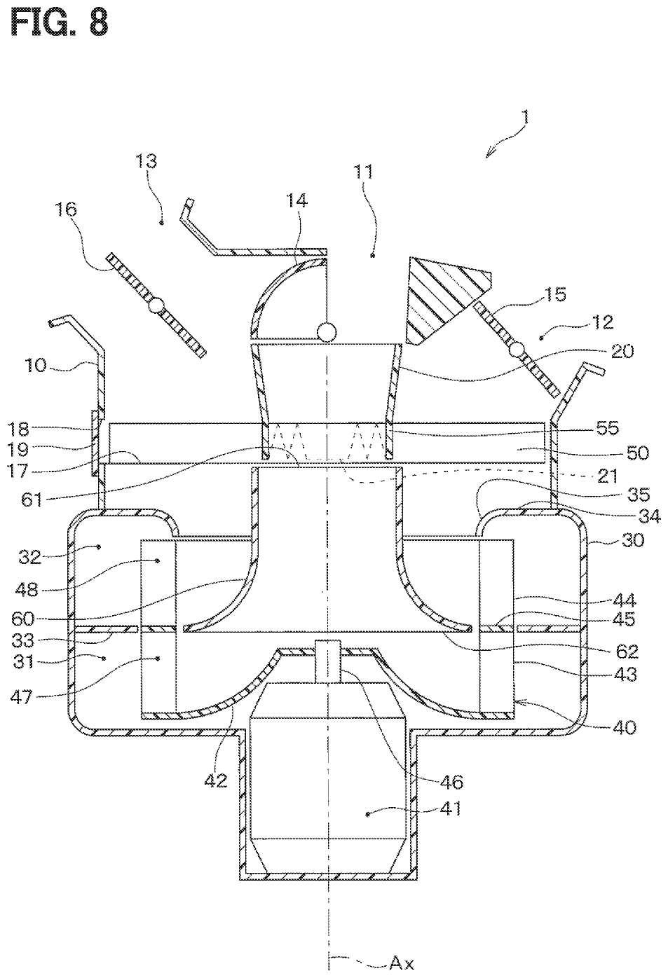

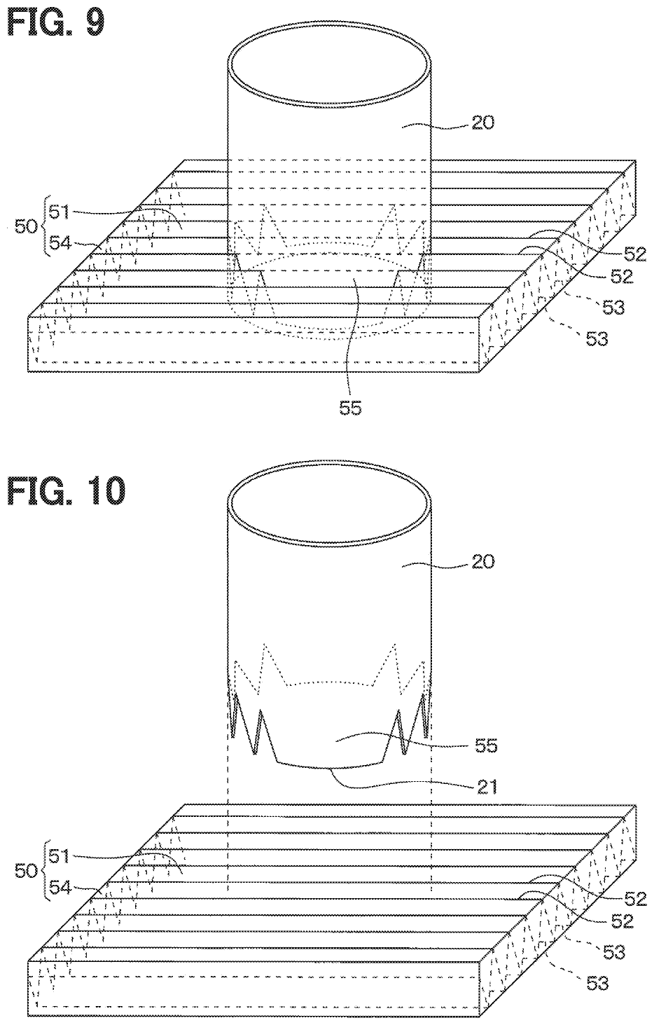

The third embodiment will be described with reference to FIGS. 8 to 10. The third embodiment is a modification of the second embodiment in which a part of the configuration of the introduction duct 20 and the upper partition plate 55 is changed. FIG. 9 is a perspective view showing the introduction duct 20, the upper partition plate 55, and the filter 50 in the blower 1 of the third embodiment, and FIG. 10 is an exploded perspective view showing the introduction duct 20, the upper partition plate 55, and the filter 50.

As shown in FIGS. 8 to 10, in the third embodiment, the introduction duct 20 and the upper partition plate 55 are integrally configured by extending a portion of the introduction duct 20 adjacent to the air outlet portion 21 into the filter 50. A part of the introduction duct 20 adjacent to the air outlet portion 21 that enters the gap between the mountain fold 52 and the valley fold 53 corresponds to the upper partition plate 55. The upper partition plate 55 integrally configured with the introduction duct 20 can partition the space on the upstream side of the filter medium 51 into a region inside the upper partition plate 55 and a region outside the upper partition plate 55.

In the third embodiment, the number of parts can be reduced by integrally configuring the introduction duct 20 and the upper partition plate 55. Further, as compared with the second embodiment, the step of fixing the filter medium 51 of the filter 50 and the upper partition plate 55 can be eliminated. Further, in the third embodiment, the mixing rate of the inside air with the outside air can be further reduced by eliminating the gap between the introduction duct 20 and the upper partition plate 55.

### Fourth Embodiment

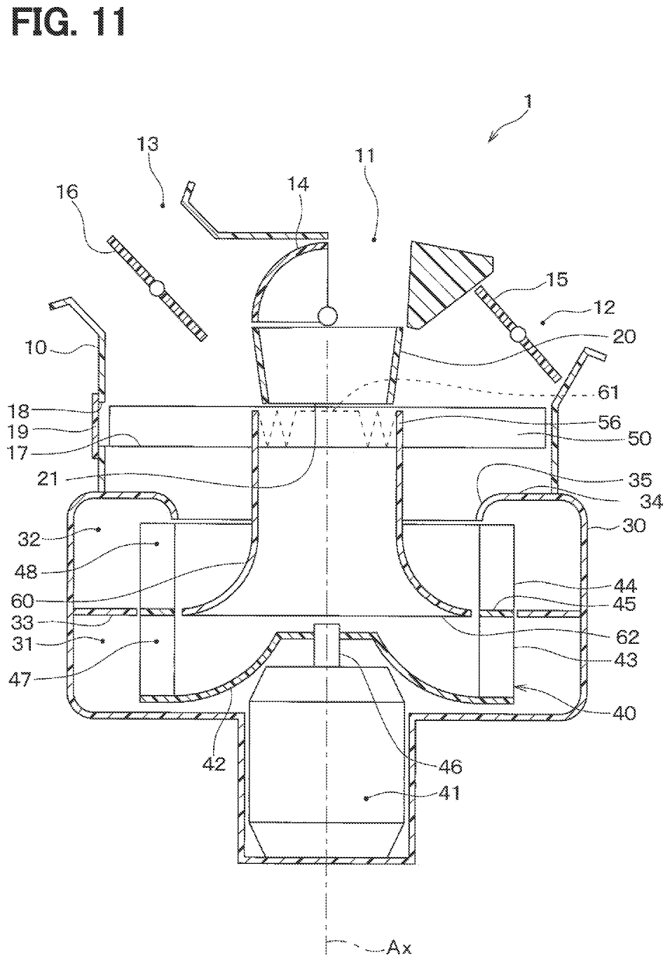

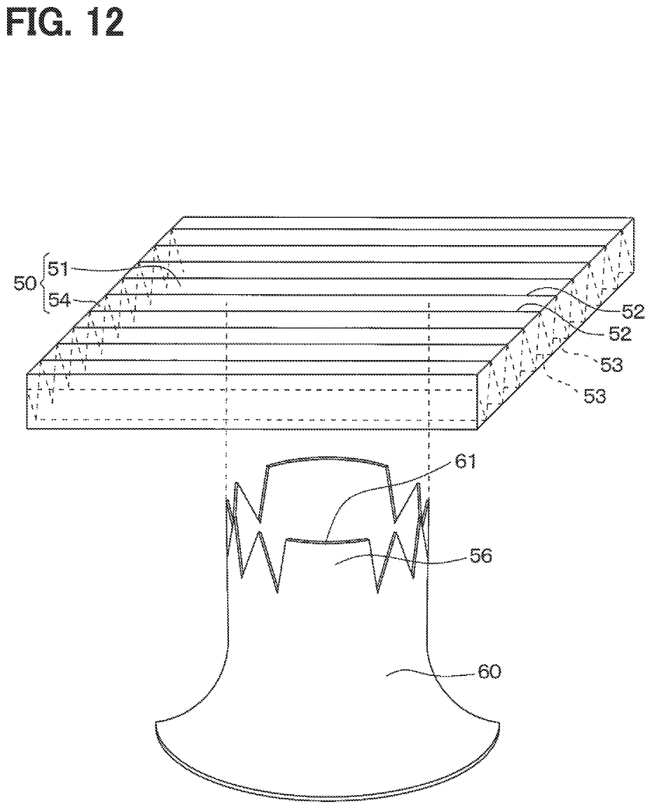

A fourth embodiment will be described with reference to FIGS. 11 and 12. The fourth embodiment is a modification of the second embodiment in which a part of the configuration of the separation cylinder 60 and the partition plate 56 is changed. FIG. 12 is an exploded perspective view of the separation cylinder 60, the partition plate 56, and the filter 50 in the blower 1 of the fourth embodiment.

As shown in FIGS. 11 and 12, in the fourth embodiment, the separation cylinder 60 and the partition plate 56 are integrally configured by extending a portion of the separation cylinder 60 adjacent to the air inlet portion 61 into the filter 50. A part of the separation cylinder 60 entering the gap between the mountain fold 52 and the valley fold 53 of the filter medium 51 corresponds to the partition plate 56. The lower partition plate 56 integrally configured with the separation cylinder 60 can partition the space on the downstream side of the filter medium 51 into a region inside the lower partition plate 56 and a region outside the lower partition plate 56.

In the fourth embodiment, the number of parts can be reduced by integrally configuring the separation cylinder 60 and the lower partition plate 56. Further, as compared with the second embodiment, the step of fixing the filter medium 51 of the filter 50 and the partition plate 56 can be abolished. Further, in the fourth embodiment, the mixing rate of the inside air with the outside air can be further reduced by eliminating the gap between the separation cylinder 60 and the partition plate 56.

### Fifth Embodiment

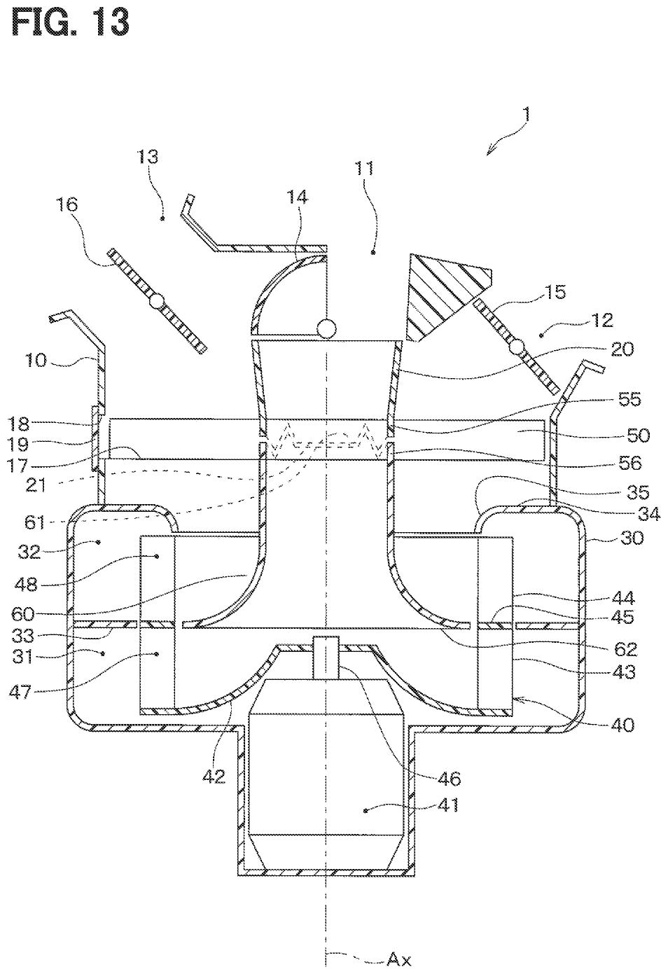

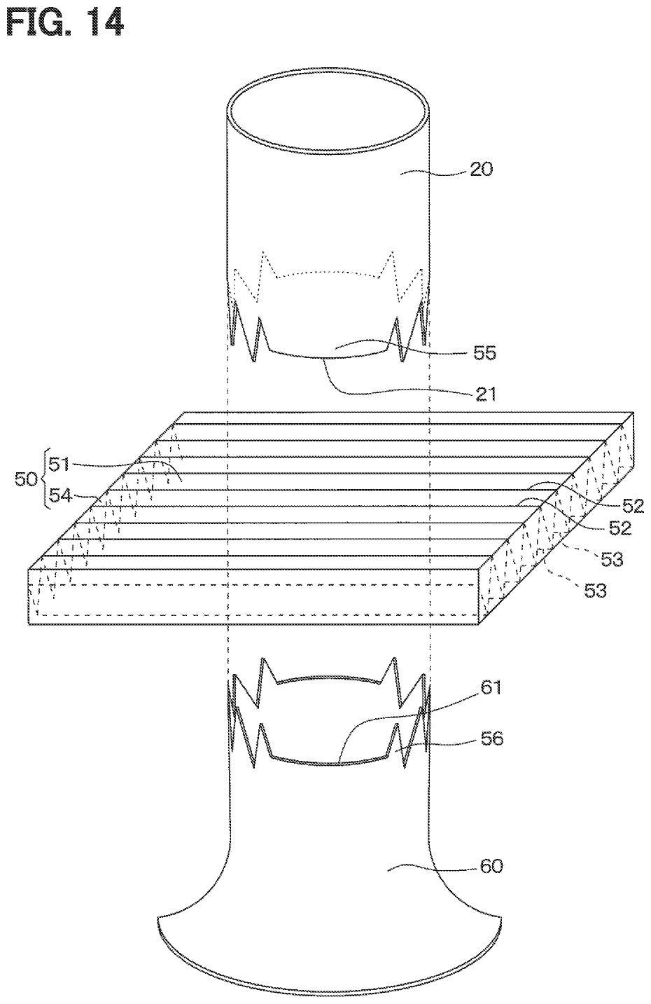

A fifth embodiment will be described with reference to FIGS. 13 and 14. The fifth embodiment is a combination of the third embodiment and the fourth embodiment. FIG. 14 is an exploded perspective view of the introduction duct 20, the upper partition plate 55, the separation cylinder 60, the lower partition plate 56, and the filter 50 in the blower 1 of the fifth embodiment.

As shown in FIGS. 13 and 14, in the fifth embodiment, the introduction duct 20 and the upper partition plate 55 are integrally configured by extending a portion of the introduction duct 20 adjacent to the air outlet portion 21 into the filter 50. A part of the introduction duct 20 that enters the gap between the mountain fold 52 and the valley fold 53 of the filter medium 51 corresponds to the upper partition plate 55. The upper partition plate 55 integrally configured with the introduction duct 20 can partition the space on the upstream side of the filter medium 51 into a region inside the upper partition plate 55 and a region outside the upper partition plate 55.

Further, in the fifth embodiment, the separation cylinder 60 and the partition plate 56 are integrally configured by extending a portion of the separation cylinder 60 adjacent to the air inlet portion 61 into the filter 50. A part of the separation cylinder 60 that enters the gap between the mountain fold 52 and the valley fold 53 of the filter medium 51 corresponds to the lower partition plate 56. The lower partition plate 56 integrally configured with the separation cylinder 60 can partition the space on the downstream side of the filter medium 51 into a region inside the lower partition plate 56 and a region outside the lower partition plate 56.

The fifth embodiment can exhibit the same effects as those of the third embodiment and the fourth embodiment.

### Sixth Embodiment

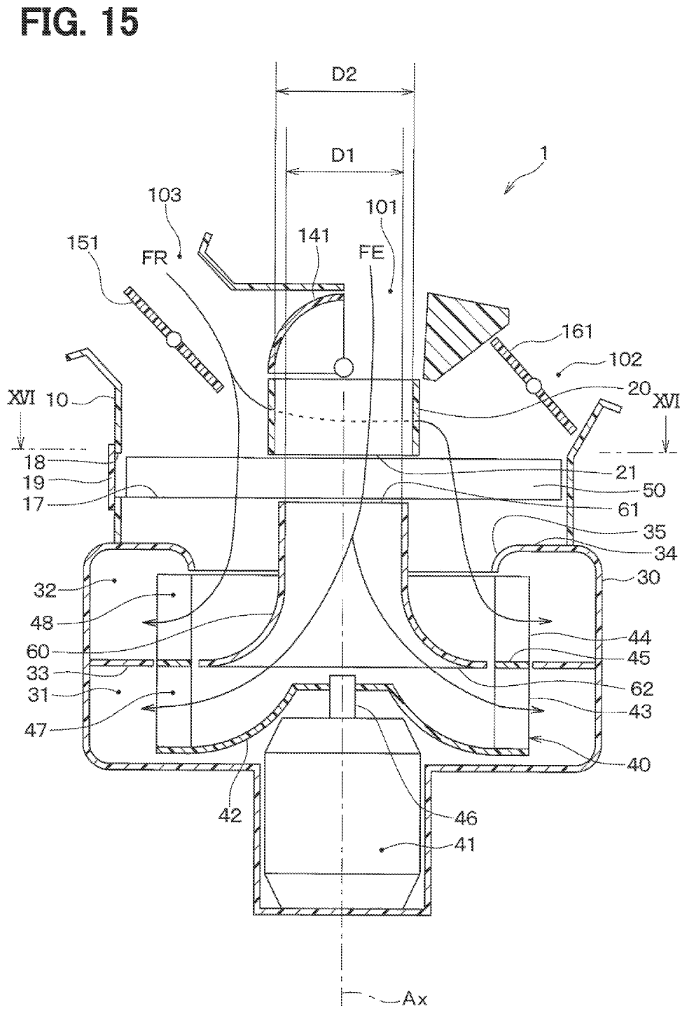

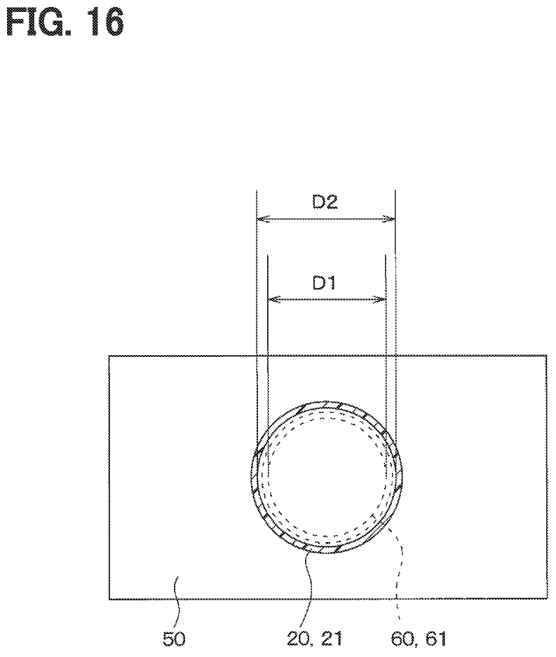

A sixth embodiment will be described with reference to FIGS. 15 and 16. In the first to fifth embodiments, the first air flowing inside the introduction duct 20 and the separation cylinder 60 is the inside air, and the second air flowing outside the introduction duct 20 and the separation cylinder 60 is the outside air. In the sixth embodiment, the first air flowing inside the introduction duct 20 and the separation cylinder 60 is the outside air and the second air flowing outside the introduction duct 20 and the separation cylinder 60 is the inside air.

As shown in FIG. 15, the air introduction box 10 in the blower 1 of the sixth embodiment has a first outside air introduction port 101, a second outside air introduction port 102, and an inside air introduction port 103. The first outside air introduction port 101 and the second outside air introduction port 102 are examples of a first introduction port into which the first air is introduced. Further, the inside air introduction port 103 is an example of a second introduction port into which the second air is introduced.

An inside/outside air door 141, an outside air door 161, an inside air door 151, an introduction duct 20, and the like are provided in the air introduction box 10. The inside/outside air door 141 selectively introduces air into the introduction duct 20 from the first outside air introduction port 101 and the inside air introduction port 103. The outside air door 161 opens and closes the second outside air introduction port 102. The inside air door 151 opens and closes the inside air introduction port 103.

The introduction duct 20 is configured to guide the air introduced from the first outside air introduction port 101 and the inside air introduction port 103, which are selectively opened and closed by the inside/outside air door 141, to a predetermined region of the filter 50. The filter 50 is arranged on the downstream side of the introduction duct 20 and on the upstream side of the impeller 40 and the separation cylinder 60.

The relationship between the air inlet portion 61 of the separation cylinder 60 and the air outlet portion 21 of the introduction duct 20 in the sixth embodiment will be described with reference to FIGS. 15 and 16. Note that FIG. 16 is a cross-sectional view taken along a line XVI-XVI of FIG. 15, but the bent shape of the filter medium 51 of the filter 50 is not shown. Further, in FIG. 16, the air outlet portion 21 of the introduction duct 20 is shown with hatching, and the air inlet portion 61 of the separation cylinder 60 is shown by a broken line.

As shown in FIGS. 15 and 16, the inner diameter of the air inlet portion 61 of the separation cylinder 60 is defined as D1. Further, the inner diameter of the air outlet portion 21 of the introduction duct 20 is defined as D2. In the sixth embodiment, the shaft core of the separation cylinder 60 and the shaft core of the introduction duct 20 substantially coincide with each other, and a relationship of D1<D2 is satisfied. Therefore, in the sixth embodiment, the inner wall of the air inlet portion 61 of the separation cylinder 60 is located inside the inner wall of the air outlet portion 21 of the introduction duct 20 over the entire circumference when viewed from the axial direction of the impeller 40. As a result, most of the air flowing through the flow path outside the introduction duct 20 flows through the flow path outside the separation cylinder 60 even when it diffuses while passing through the filter 50. Therefore, after the air flowing through the flow path outside the introduction duct 20 has passed through the filter 50, it is suppressed from being mixed into the flow path inside the separation cylinder 60. In FIGS. 15 and 16, the inner diameter D1 of the air inlet portion 61 of the separation cylinder 60 is smaller than the inner diameter D2 of the air outlet portion 21 of the introduction duct 20 by a magnitude smaller than the thickness of the separation cylinder 60.

The blower 1 can be configured to set an air suction mode such as an inside/outside air two-layer mode in which the outside air and the inside air are simultaneously sucked and separately blown out, an outside air mode in which the outside air is sucked in and blown out, and an inside air mode in which the inside air is sucked in and blown out.

### <Inside/Outside Air Two-Layer Mode>

FIG. 15 shows a state in which the inside/outside air two-layer mode is set in the blower 1. At that time, the inside/outside air door 141 is displaced to a position where the first outside air introduction port 101 and the introduction duct 20 communicate with each other and the communication between the inside air introduction port 103 and the introduction duct 20 is cut off. The outside air door 161 is displaced to a position where the second outside air introduction port 102 is closed. The inside air door 151 is displaced to a position where the inside air introduction port 103 is opened. When the impeller 40 rotates in this state, the outside air is introduced from the first outside air introduction port 101 to the inside of the introduction duct 20, and the inside air is introduced from the inside air introduction port 103 to the outside of the introduction duct 20.

As shown by the arrow FE in FIG. 15, the outside air introduced from the first outside air introduction port 101 to the inside of the introduction duct 20 passes through the filter 50, flows inside the separation cylinder 60, and is sucked into the first blade flow path 47 of the impeller 40 so as to be blown out to the first ventilation passage 31.

As shown by the arrow FR in FIG. 15, the inside air introduced from the inside air introduction port 103 to the outside of the introduction duct 20 passes through the filter 50, and is sucked into the second blade flow path 48 of the impeller 40 from the flow path outside the separation cylinder 60 so as to be blown out to the second ventilation passage 32. In the sixth embodiment, the inner wall of the air inlet portion 61 of the separation cylinder 60 is provided inside the inner wall of the air outlet portion 21 of the introduction duct 20 over the entire circumference. Therefore, most of the inside air flowing from the flow path outside the introduction duct 20 to the filter 50 flows through the flow path outside the separation cylinder 60 even when it diffuses when passing through the filter medium 51 of the filter 50, and is suppressed from being mixed in the inner flow path of the separation cylinder 60. Therefore, the mixing ratio of the inside air to the outside air flowing through the flow path inside the separation cylinder 60 is small.

The outside air flowing through the first ventilation passage 31 and the inside air flowing through the second ventilation passage 32 are introduced into an air conditioning unit (not shown), and are adjusted to have a desired temperature and humidity inside the air conditioning unit, so as to be blown out from each outlet to the cabin. When the inside/outside air two-layer mode is set in the blower 1, the outside air flowing through the first ventilation passage 31 is mainly blown out to the front windshield from the defroster outlet provided in the cabin. In the sixth embodiment, since the mixing ratio of the inside air to the outside air flowing through the first ventilation passage 31 is small, fogging of the front windshield can be reliably restricted. In the sixth embodiment, the description of the outside air mode and the inside air mode will be omitted.

In the blower 1 of the sixth embodiment, when viewed from the axial direction of the impeller 40, the inner wall of the air inlet portion 61 of the separation cylinder 60 is provided inside the inner wall of the air outlet portion 21 of the introduction duct 20 over the entire circumference. As a result, almost all of the inside air flowing through the flow path outside the introduction duct 20, when the inside/outside air two-layer mode is set, flows to the outside flow path of the separation cylinder 60 after passing through the filter 50. Therefore, when the inside/outside air two-layer mode is set, the inside air is suppressed from being mixed in the inner flow path of the separation cylinder 60. Thus, the mixing ratio of the inside air into the outside air flowing through the inner flow path of the separation cylinder 60 is reduced. Therefore, when the outside air is blown out from the defroster outlet, the window fogging can be restricted.

It should be noted that the configuration of the partition plates 55 and 56 of the filter 50 described in the second to fifth embodiments and the modifications thereof can be combined with the configuration of the sixth embodiment.

### Other Embodiments

The present disclosure is not limited to the embodiments described above, and can be modified as appropriate. The above embodiments are not independent of each other, and can be appropriately combined except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. In each of the above embodiments, when the shapes, positional relationships, and the like of the components and the like are referred to, the shapes, positional relationships, and the like are not limited thereto unless otherwise specified or limited to specific shapes, positional relationships, and the like in principle.

For example, in the embodiments, the introduction duct 20 and the separation cylinder 60 have the same shape and are arranged substantially coaxially with the filter 50 interposed therebetween, but not limited to this. The introduction duct 20 and the separation cylinder 60 may have different shapes. Further, the shaft of the introduction duct 20 and the shaft of the separation cylinder 60 may be offset from each other.

Further, in the embodiments, the partition plates 55 and 56 have the upper partition plate 55 and the lower partition plate 56, but not limited to this. The partition plates 55 and 56 may be only the upper partition plate 55 or may be only the lower partition plate 56.

Further, in the embodiments, the scroll casing 30 is arranged on the downstream side of the air introduction box 10, but not limited to this. The casing arranged on the downstream side of the air introduction box 10 may be a casing with a ventilation path having a shape different from that of the scroll.

According to the first aspect shown in a part or all of the embodiments, a blower for an air conditioner to set an inside/outside air two-layer mode in which the first air and the second air are separately supplied to a cabin includes an air introduction box, an introduction duct, a casing, an impeller, a filter and separation cylinder. The air introduction box has a first introduction port into which the first air is introduced and a second introduction port into which the second air is introduced. The introduction duct is provided inside the air introduction box so that the first air flows inside the introduction duct and the second air flows outside the introduction duct when the inside/outside air two-layer mode is set. The casing forms a ventilation path through which the first air and the second air flow on the downstream side of the air introduction box. The impeller is provided inside the casing to suck in the first air and the second air introduced into the air introduction box, and blow them out to the first air passage and the second air passage formed on the downstream side of the impeller. The filter is provided on the downstream side of the introduction duct and on the upstream side of the impeller, and captures a foreign matter contained in the air flowing from the inside and the outside of the introduction duct to the impeller. The separation cylinder is formed in a tubular shape and is provided inside the impeller, and is formed so as to extend radially outward from an air inlet portion provided on the filter side through the inside of the impeller. When the first air is the inside air and the second air is the outside air, the inner wall of the air inlet portion of the separation cylinder is located outside of the inner wall of the air outlet portion of the introduction duct over the entire circumference when viewed from the axial direction of the impeller. When the first air is the outside air and the second air is the inside air, the inner wall of the air inlet portion of the separation cylinder is located inside of the inner wall of the air outlet portion of the introduction duct over the entire circumference when viewed from the axial direction of the impeller.

According to the second aspect, the blower further comprises a partition plate provided on the filter. The partition plate divides the space inside the filter into a plurality of regions so that the air flowing out from the air outlet portion of the introduction duct flows into the air inlet portion of the separation cylinder via the filter.

Accordingly, the first air flowing out from the air outlet portion of the introduction duct, when the inside/outside air two-layer mode is set, flows through the inner region partitioned by the partition plate when passing through the filter, and almost all of the air flows into the air inlet portion of the separation cylinder. Therefore, when the first air is the inside air and the second air is the outside air, the inside air is suppressed from leaking to the flow path outside the separation cylinder, when the inside/outside air two-layer mode is set, so that the mixing rate of inside air with the outside air flowing through the flow path outside the separation cylinder is reduced. Even when the first air is the outside air and the second air is the inside air, the inside air is restricted from leaking to the flow path inside the separation cylinder when the inside/outside air two-layer mode is set. Thus, the mixing rate of the inside air with the outside air flowing through the flow path inside the separation cylinder is reduced. Therefore, when the outside air is blown out from the defroster outlet, the window fogging can be restricted.

According to the third aspect, a blower for an air conditioner capable of setting an inside/outside air two-layer mode in which the first air and the second air are separately supplied to a cabin includes an air introduction box, an introduction duct, a casing, an impeller, a filter, a separation cylinder and a partition plate. The air introduction box has a first introduction port into which the first air is introduced and a second introduction port into which the second air is introduced. The introduction duct is provided inside the air introduction box so that the first air flows inside the introduction duct and the second air flows outside the introduction duct when the inside/outside air two-layer mode is set. The casing forms a ventilation path through which the first air and the second air flow on the downstream side of the air introduction box. The impeller is provided inside the casing, to suck in the first air and the second air introduced into the air introduction box, and blow them out to the first air passage and the second air passage formed on the downstream side of the impeller. The filter is provided on the downstream side of the introduction duct and on the upstream side of the impeller, and captures a foreign matter contained in the air flowing from the inside and the outside of the introduction duct to the impeller. The separation cylinder is formed in a tubular shape and is provided inside the impeller, and is formed so as to extend radially outward from an air inlet portion provided on the filter side through the inside of the impeller. The partition plate is provided on the filter, and divides the space inside the filter into a plurality of regions so that the air flowing out from the air outlet portion of the introduction duct flows into the air inlet portion of the separation cylinder via the filter. The third aspect can also exert the same action and effect as the second aspect.

According to the fourth aspect, the partition plate is composed of a member separate from the introduction duct and the separation cylinder, and is fixed to the filter. Accordingly, the filter and the partition plate can be integrated and easily attached to and detached from the blower.

According to the fifth aspect, the introduction duct and the partition plate are integrally formed by extending a portion of the introduction duct facing the air outlet portion into the space inside the filter. Accordingly, it is possible to reduce the number of parts. Further, the mixing rate of the inside air with the outside air can be further reduced by eliminating the gap between the introduction duct and the partition plate.

According to the sixth aspect, the separation cylinder and the partition plate are integrally formed by extending a portion of the separation cylinder facing the air inlet portion to the space inside the filter. Accordingly, it is possible to reduce the number of parts. Further, the mixing ratio of the inside air to the outside air can be further reduced by eliminating the gap between the separation cylinder and the partition plate.

According to the seventh aspect, the partition plate has an upper partition plate and a lower partition plate. The introduction duct and the upper partition plate are integrally configured by extending a portion of the introduction duct facing the air outlet portion into the space inside the filter. Further, the separation cylinder and the partition plate are integrally formed by extending a portion of the separation cylinder facing the air inlet portion into the space inside the filter. Accordingly, it is possible to reduce the number of parts and to reduce the mixing ratio of the inside air to the outside air.

What is claimed is:

1. A blower for an air conditioner in which an inside/outside air two-layer mode is to be set to supply a first air and a second air separately to a cabin, the blower comprising:
an air introduction box having a first introduction port into which the first air is introduced and a second introduction port into which the second air is introduced;
an introduction duct provided in the air introduction box, the first air flowing inside the introduction duct and the second air flowing outside the introduction duct when the inside/outside air two-layer mode is set;
a casing that forms a ventilation path through which the first air and the second air flow on a downstream side of the air introduction box;
an impeller provided inside the casing to suck in the first air and the second air introduced into the air introduction box and blow out the first air and the second air into a first air passage and a second air passage on a downstream side of the impeller;
a filter arranged on a downstream side of the introduction duct and an upstream side of the impeller so as to capture a foreign matter contained in air flowing from an inside and an outside of the introduction duct to the impeller; and
a separation cylinder arranged inside the impeller and having an air inlet portion adjacent to the filter, the separation cylinder being formed so as to extend radially outward from the air inlet portion through the inside of the impeller, wherein
when the first air is air inside the cabin and the second air is air outside the cabin, an inner wall of the air inlet portion of the separation cylinder is located outside an inner wall of an air outlet portion of the introduction duct over an entire circumference when viewed in an axial direction of the impeller, and
when the first air is air outside the cabin and the second air is air inside the cabin, an inner wall of the air inlet portion of the separation cylinder is located inside an inner wall of the air outlet portion of the introduction duct over an entire circumference when viewed in an axial direction of the impeller.

2. The blower according to claim 1, further comprising a partition plate provided on the filter to partition an inside space of the filter into a plurality of regions so that air flowing out of the air outlet portion of the introduction duct flows into the air inlet portion of the separation cylinder via the filter.

3. A blower for an air conditioner in which an inside/outside air two-layer mode is to be set to supply a first air and a second air separately to a cabin, the blower comprising:
an air introduction box having a first introduction port into which the first air is introduced and a second introduction port into which the second air is introduced;
an introduction duct provided in the air introduction box, the first air flowing inside the introduction duct and the second air flowing outside the introduction duct when the inside/outside air two-layer mode is set;
a casing that forms a ventilation path through which the first air and the second air flow on a downstream side of the air introduction box;
an impeller provided inside the casing to suck in the first air and the second air introduced into the air introduction box and blow out the first air and the second air into a first air passage and a second air passage on a downstream side of the impeller;
a filter arranged on a downstream side of the introduction duct and an upstream side of the impeller so as to capture a foreign matter contained in air flowing from an inside and an outside of the introduction duct to the impeller;
a separation cylinder arranged inside the impeller and having an air inlet portion adjacent to the filter, the separation cylinder being formed so as to extend radially outward from the air inlet portion through the inside of the impeller; and
a partition plate provided on the filter to partition an inside space of the filter into a plurality of regions so that air flowing out of an air outlet portion of the introduction duct flows into the air inlet portion of the separation cylinder via the filter.

4. The blower according to claim 3, wherein the partition plate is a member separate from the introduction duct and the separation cylinder and is fixed to the filter.

5. The blower according to claim 3, wherein a part of the introduction duct facing the air outlet portion extends to an inside space of the filter such that the introduction duct and the partition plate are integrally configured.

6. The blower according to claim 3, wherein a part of the separation cylinder facing the air inlet portion extends to an inside space of the filter such that the separation cylinder and the partition plate are integrally configured.

7. The blower according to claim 3, wherein
the partition plate has
an upper partition plate integrally configured with the introduction duct, a part of the introduction duct facing the air outlet portion extending to an inside space of the filter, and
a lower partition plate integrally configured with the separation cylinder, a part of the separation cylinder facing the air inlet portion extending to an inside space of the filter.

8. The blower according to claim 1, wherein the inner wall of the air inlet portion of the separation cylinder is located outside the inner wall of the air outlet portion of the introduction duct over the entire circumference.

9. The blower according to claim 1, wherein the inner wall of the air inlet portion of the separation cylinder is located inside the inner wall of the air outlet portion of the introduction duct over the entire circumference.
